(19) United States
(12) Patent Application Publication
(10) Pub. No.: US 2019/0108190 A1
(43) Pub. Date: Apr. 11, 2019

(54) Meet someone new upon first sight that's within a 360 degree radius in a distance of 360 feet, yards, or meters, by describing through a mobile phone application, their hair color and length, eye color, clothing, height, weight and ethnicity" hereinafter abbreviated as 'Meet360"

(71) Applicants: Lewellyn Charles Cox, IV, El Paso, TX (US); Aaron Joseph Cox, El Paso, TX (US)

(72) Inventors: Lewellyn Charles Cox, IV, El Paso, TX (US); Aaron Joseph Cox, El Paso, TX (US)

(21) Appl. No.: 15/731,174

(22) Filed: May 1, 2017

(51) Int. Cl. G06F 16/9535; G06F 16/9537

(52) U.S. Cl. CPC G06F 16/9535; G06F 16/9537

(57) ABSTRACT

The “Meet360”, “Mobile Phone Application” (abbreviated for short, hereinafter as “App.”), allows a website greeting transmitted to an unknown individual only after physical sighting. The “App.”, requires that both the initial sender of the greeting, and the receiver of the initial greeting physically cross paths, in recent time, and were located at the same location within 360 feet, yards, or meters.

Registered members of the “Meet360” website can send a initial greeting request asking in realtime whether it's okay to communicate 20 words. Registered members are allowed to backdate a description of someone he or she has seen in the past 48 hours. The members and users must use the “Meet360” website to describe and communicate only with other members or users.

Once the website determines a matching description of a described participating user or member who is described, a current photo list is displayed, and the requesting user, or member may then choose said photo/picture to begin communication [request]. First, the requesting user must request permission to send an initial greeting, and if the receiving user accepts the request granting permission, the requesting user may send a 20 word message. [The 48 hour limitation to backdating is to allow a window of allowable locating, after 48 hours, the system deletes location records] (please notice specific 48 hour privacy return claim).

### BACKGROUND SUMMARY

The “Meet360” “App.”, derives its locations of it's members using Global Positioning Satellite (GPS), upon a request by a member/user to participate. The membership photo and clothing description is stored on the “Meet360 Host” hard drive, or an outsourced cloud based digital storage system. Members can choose to deactivate the (GPS), and use manual input, to signal locations, when participating.

### DETAILED DESCRIPTION

The Mobile phone application software works for members or users who are registered, with the “Meet360 Host”. Only registered members are allowed to download the software for free. After downloading the software to a mobile phone the “Meet360” Host” asks permission to use (GPS), to detect locations. A user has the option to input his or her location in the alternative

The user must upload a photo into the “Meet360 Host”. The User must also describe, his or her personal physical appearance, or features, such as hair color and length, eye color, height, weight, ethnicity, and on certain occasions clothes. Describing clothes becomes necessary, when a user wants to be contacted, and seeks to assure that he or she can be easily described.

Once a user is requested for an initial greeting, the receiving user can choose to accept, deny, or block. If, accepted the user can add the new friend in his or her “Acquaintance List”. The “Acquaintance list” allows future communication.

The participating members actively using the “Meet360” software, must save a clear description on their “Meet360” homepage. On days where a user/member would like to assure the best description, the software user or member, can describe his or her clothing, and other accessories including anything associated such as a car, bicycle, motorcycle, skateboard, skates, and carrying bag. The “Meet360” software will allow the last three digits of the vehicle's license plate, if such information is stored on the member's profile.

The participating user can also signal his or her or others location by typing in the physical address where they are located. If, a user who seeks to initiate communication, and sends a greeting request, after successfully locating the person he or she has just seen [visually in-person], then that person can choose the matching photo displayed on the “Meet360” “Found List”.

By choosing the photograph matching the description the seeking user can request to send a greeting. If the request is accepted the initiating sender can send a initial greeting limited to 20 words. Once the receiver decides to add as an acquaintance the word restriction is removed, and future communication can be freely communicated. The “Meet360 Host” will send an email or text to the receiving user/member, notifying the receiver that a request to send a greeting is pending. The receiver has the option to accept, reject or block, a initiating user's request to send a greeting, and in the event of a rejection or block, the “Meet360 Host” will notify the requester after 48 hours. [This allows a discrete rejection, in case these two individuals are in the same location at the time of the initial request, this is relevant for safety concerns].

1. The “Meet360” mobile phone application, is a descriptive visual appearance communication system, which allows users to describe a participating users by their clothes, their height, weight, and hair and eye color. This claim also allows a search for individuals using the vehicle license plate in conjunction with a minimal physical appearance description of the persons's hair and race. The purpose of this mobile phone application software is to allow perfect strangers, whom have just crossed paths and one of the two is capable of describing the individual's hair, eye, height, weight, race and accessories, such as car, boat, skates, skateboard, bicycle or motorcycle with licensee plate. When describing a car, it is only necessary to input the last three digits of the license plate.
This claim allows a backdated search of up to 48 hours. In order to use the backdated search, the user must save the initial description almost immediately and then the user may access the 48 hour backdated appearance search. Upon a successful match, the user can select from a list of matches, which are displayed by pictures. All individuals located within 360 feet, yards or meters whom, are participating at that very moment in time may be accessed via this social media smart phone application. After a match is made the initiating user may request to send a greeting. If the request is accepted the user may send a one time greeting. After receiving user allows a one time greeting, he or she may add as an acquaintance. Once accepted as an acquaintance the 20 word restriction is removed. The “Meet360”, claim is not to the coding or method of computer operations, but only the function involving descriptive requests to communicate with strangers via a smart phone application that sends its participating users an email or text.
